(19) United States
(12) Patent Application Publication
(10) Pub. No.: US 2026/0370342 A1
(43) Pub. Date: Nov. 19, 2026

(54) COMMUNICATION APPARATUS, FREQUENCY OFFSET COMPENSATION METHOD AND PROGRAM

(71) Applicant: NTT, Inc., Tokyo (JP)

(72) Inventors: Takahiro SUZUKI, Musashino-shi (JP); Junichi KANI, Musashino-shi (JP); Sang-Yuep KIM, Musashino-shi (JP)

(73) Assignee: NTT, Inc., Tokyo (JP)

(21) Appl. No.: 19/121,680

(22) PCT Filed: Nov. 7, 2022
(86) PCT No.: PCT/JP2022/041287

§ 371 Date: Apr. 16, 2025

(51) Int. Cl. H04B 10/61

(52) U.S. Cl. CPC H04B 10/6164

(57) ABSTRACT

A communication device includes: a reception unit that receives a modulated signal including signals of a plurality of symbols; and a frequency offset compensation unit that calculates a frequency offset of each signal of each symbol included in the modulated signal received by the reception unit, calculates a statistical value of the calculated frequency offset of each signal of each symbol, and compensates for the frequency offset by rotating a phase of the signal of each symbol on the basis of the calculated statistical value of the frequency offset and a value of the frequency offset corresponding to the signal of each symbol.

### TECHNICAL FIELD

The present invention relates to a communication device, a frequency offset compensation method, and a program.

### BACKGROUND ART

In the related art, a frequency offset compensation unit illustrated in FIG. 5 is configured to compensate for a frequency offset of a signal received in a communication device (see, for example, Non Patent Literature 1). FIG. 5 is a diagram illustrating an example of a configuration of a frequency offset compensation unit 100 in the related art. The frequency offset compensation unit 100 performs frequency offset compensation on an m-phase shift keying (m-PSK) modulated signal. m corresponds to the number of complex symbols, which is the number of constellation points. In Non Patent Literature 1, quadrature PSK (QPSK) is described as an example, where m=4 is indicated.

The frequency offset compensation unit 100 includes a plurality of calculation units 101, a plurality of multiplication units 102, a plurality of calculation units 103, a plurality of calculation units 104, a plurality of calculation units 105, a plurality of addition units 106, a buffer 107, and a plurality of calculation units 108. Here, a case where a frequency offset φ(k) is calculated for a signal r(k) of a k-th (k is an integer equal to or greater than 1) symbol will be described as an example.

First, the frequency offset compensation unit 100 calculates a complex conjugate of a signal r(k−1) of a (k−1)-th symbol, which is a symbol immediately before the signal r(k) of the k-th symbol, in the calculation unit 101. Next, the frequency offset compensation unit 100 multiplies the signal r(k) of the k-th symbol by the complex conjugate of the signal r(k−1) of the (k−1)-th symbol, which is a symbol immediately before the signal r(k) of the k-th symbol, in the multiplication unit 102. Next, the frequency offset compensation unit 100 calculates the m-th power of the multiplication result in the calculation unit 103.

Next, the frequency offset compensation unit 100 adds a plurality of symbols in the calculation unit 104. Next, the frequency offset compensation unit 100 performs angle calculation on the addition result of the plurality of symbols in the calculation unit 105, and divides the value after the angle calculation by m. Next, the frequency offset compensation unit 100 adds the calculation result of the calculation unit 105 and the frequency offset stored in the buffer 107, in the addition unit 106. The frequency offset is sequentially added between symbols and stored in the buffer 107. Then, the frequency offset compensation unit 100 compensates for the frequency offset by rotating the phase of the signal r(k) of the k-th symbol by the amount of the frequency offset obtained by finally adding the phases of the signals in the calculation unit 108. Here, compensation of the frequency offset (k) for the signal r(k) of the k-th symbol has been described as an example, but similar processing is also performed for signals from the (k+1)-th symbol onwards.

### CITATION LIST

### Non Patent Literature

Non Patent Literature 1: Andreas Leven, Noriaki Kaneda, Ut-Va Koc and Young-Kai Chen, “Frequency Estimation in Intradyne Reception”, in IEEE PHOTONICS TECHNOLOGY LETTERS, VOL. 19, NO. 6, Mar. 15, 2007, pp. 366-368, Digital Object Identifier-10.1109/LPT.2007.891893.

### SUMMARY OF INVENTION

### Technical Problem

However, in the configuration in the related art, the process of adding the frequency offset calculated for each symbol is a sequential operation. Therefore, the calculation of r(k)×exp[−jφ(k)] is sequentially performed, and there is a problem that high-speed parallel processing cannot be implemented.

In view of the above circumstances, an object of the present invention is to provide a technique capable of reducing the number of sequential processing operations for frequency offset compensation and implementing parallel processing.

### Solution to Problem

According to one aspect of the present invention, there is provided a communication device including: a reception unit configured to receive a modulated signal including signals of a plurality of symbols; and a frequency offset compensation unit configured to calculate a frequency offset of each signal of each symbol included in the modulated signal received by the reception unit, calculate a statistical value of the calculated frequency offset of each signal of each symbol, and compensate for the frequency offset by rotating a phase of the signal of each symbol on the basis of the calculated statistical value of the frequency offset and a value of the frequency offset corresponding to the signal of each symbol.

According to another aspect of the present invention, there is provided a frequency offset compensation method including: receiving a modulated signal including signals of a plurality of symbols; and calculating a frequency offset of each signal of each symbol included in the received modulated signal, calculating a statistical value of the calculated frequency offset of each signal of each symbol, and compensating for the frequency offset by rotating a phase of the signal of each symbol on the basis of the calculated statistical value of the frequency offset and a value of the frequency offset corresponding to the signal of each symbol.

According to still another aspect of the present invention, there is provided a program for causing a computer to execute: a reception step of receiving a modulated signal including signals of a plurality of symbols; and a frequency offset compensation step of calculating a frequency offset of each signal of each symbol included in the modulated signal received in the reception step, calculating a statistical value of the calculated frequency offset of each signal of each symbol, and compensating for the frequency offset by rotating a phase of the signal of each symbol on the basis of the calculated statistical value of the frequency offset and a value of the frequency offset corresponding to the signal of each symbol.

### Advantageous Effects of Invention

According to the present invention, it is possible to reduce the number of sequential processing operations for frequency offset compensation and implement parallel processing.

### BRIEF DESCRIPTION OF DRAWINGS

FIG. 1 A diagram illustrating a specific example of a reception device according to an embodiment.

FIG. 2 A diagram illustrating an example of a configuration of a frequency offset compensation unit according to the embodiment.

FIG. 3 A flowchart illustrating a flow of processing of the reception device according to the embodiment.

FIG. 4 A diagram illustrating an example of a configuration of a server according to a modification example.

FIG. 5 A diagram illustrating an example of a configuration of a frequency offset compensation unit in the related art.

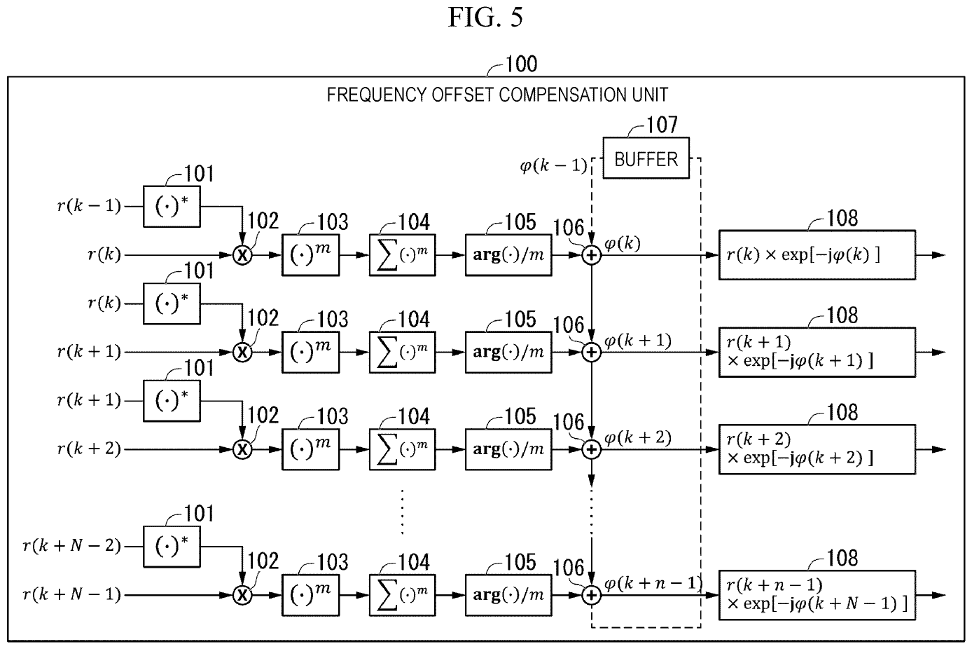

### DESCRIPTION OF EMBODIMENTS

An embodiment of the present invention will be described below with reference to the drawings.

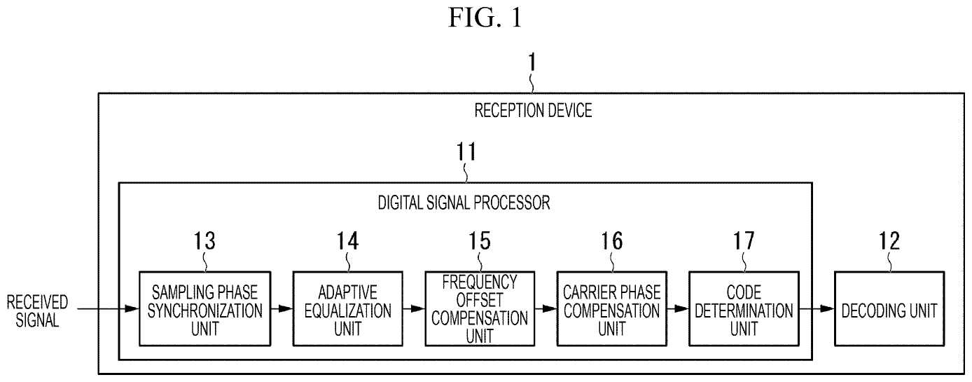

FIG. 1 is a diagram illustrating a specific example of a reception device 1 according to an embodiment. The reception device 1 receives a modulated signal transmitted from a transmission device. The modulated signal transmitted from the transmission device is, for example, an m-PSK modulated signal. The reception device 1 calculates a frequency offset on the basis of the received modulated signal, and compensates for the frequency offset of the modulated signal on the basis of the calculated frequency offset.

The reception device 1 includes a digital signal processor 11 and a decoding unit 12. The digital signal processor 11 performs signal processing such as sampling phase synchronization, adaptive equalization, frequency offset compensation, carrier phase compensation, and code determination on the received signal. The decoding unit 12 performs decoding processing such as error correction on the received signal subjected to the signal processing by the digital signal processor 11. The reception device 1 is one aspect of a communication device.

The digital signal processor 11 includes a sampling phase synchronization unit 13, an adaptive equalization unit 14, a frequency offset compensation unit 15, a carrier phase compensation unit 16, and a code determination unit 17. The sampling phase synchronization unit 13 synchronizes the phase of the received signal with a reference phase, samples the received signal, and converts the received signal into a digital signal. The adaptive equalization unit 14 performs adaptive equalization processing using a finite impulse response (FIR) filter on the digital signal converted by the sampling phase synchronization unit 13.

The frequency offset compensation unit 15 compensates for the frequency offset of the digital signal that has been subjected to adaptive equalization processing by the adaptive equalization unit 14. The carrier phase compensation unit 16 compensates for the phase offset of the digital signal after frequency offset compensation. The code determination unit 17 performs symbol determination on the digital signal after phase offset compensation.

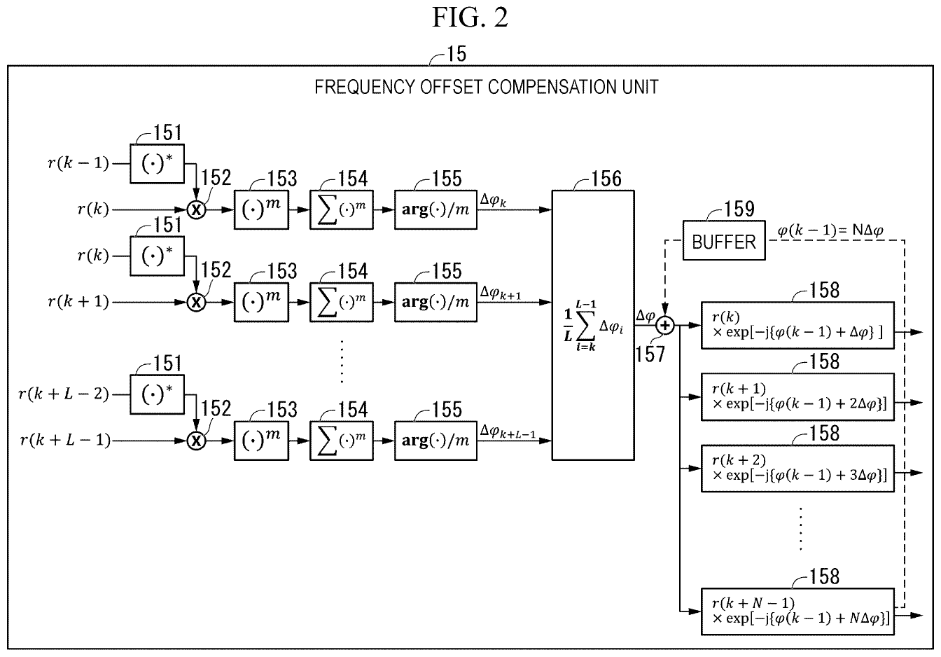

FIG. 2 is a diagram illustrating an example of the configuration of the frequency offset compensation unit 15 according to the embodiment. The frequency offset compensation unit 15 calculates frequency offsets Δφₖ, Δφₖ₊₁, . . . , Δφ_{k+L-1} for each of signals r(k), r(k+1), . . . , r(k+L−1) of a plurality of symbols, and calculates statistical values of the frequency offsets Δφₖ, Δφₖ₊₁, . . . , Δφ_{k+L-1}. For example, the frequency offset compensation unit 15 calculates an average value as the statistical value. Thereafter, the frequency offset compensation unit 15 rotates the phase of the signal r(k+n−1) by φ(k−1)+nΔφₖ. Here, n is an integer equal to or greater than 0. As shown in the following Formula (1), the process of rotating the phase of an input signal can be expressed by a matrix. Therefore, the process can be executed in parallel. Note that L is a value equal to or less than N.

$$[ Math . 1 ]$$

$$[ r ( k ) , r ( k + 1 ) , … , r ( k + N - 1 ) ] [ \begin{matrix}exp [ - j \{ φ ( k - 1 ) + Δ {φ}_{k} \} ] \\ exp [ - j \{ φ ( k - 1 ) + 2 Δ {φ}_{k} \} ] \\ ⋮ \\ exp [ - j \{ φ ( k - 1 ) + Δ N {φ}_{k} \} ]\end{matrix} ] \qquad Formula ( 1 )$$

The frequency offset compensation unit 15 includes a plurality of calculation units 151, a plurality of multiplication units 152, a plurality of calculation units 153, a plurality of calculation units 154, a plurality of calculation units 155, a calculation unit 156, a plurality of addition units 157, a plurality of calculation units 158, and a buffer 159. The plurality of calculation units 151, the plurality of multiplication units 152, the plurality of calculation units 153, the plurality of calculation units 154, and the plurality of calculation units 155 function as a frequency offset calculation unit that calculates a frequency offset. The plurality of calculation units 158 and the buffer 159 function as a phase rotation unit that rotates the phase of the signal of each symbol.

The calculation unit 151 calculates the complex conjugate of the signal of a symbol immediately before a signal of a certain symbol. For example, the calculation unit 151 calculates the complex conjugate of the signal r(k−1) of the (k−1)-th symbol, which is a symbol immediately before the signal r(k) of the k-th symbol. The multiplication unit 152 multiplies a signal of a certain symbol by a complex conjugate of a signal of a symbol immediately before the signal of the certain symbol. For example, the multiplication unit 152 multiplies the signal r(k) of the k-th symbol by the complex conjugate of the signal r(k−1) of the (k−1)-th symbol, which is a symbol immediately before the signal r(k) of the k-th symbol.

The calculation unit 153 calculates the m-th power of the multiplication result by the multiplication unit 152. The calculation unit 154 adds a plurality of symbols in the calculation result of the calculation unit 153. The calculation unit 155 performs angle calculation on the basis of the addition result of the plurality of symbols, and divides the value after the angle calculation by m. Accordingly, the frequency offset compensation unit 15 calculates frequency offsets Δφₖ, Δφₖ₊₁, . . . , Δφ_{k+L-1} for the signals r(k), r(k+1), . . . , r(k+L−1) of each symbol.

The calculation unit 156 calculates statistical values of the frequency offsets Δφₖ, Δφₖ₊₁, . . . , and Δφ_{k+L-1} calculated by each calculation unit 155. For example, the calculation unit 156 calculates an average value as a statistical value on the basis of the following Formula (2). In this way, the calculation unit 156 functions as a statistical frequency offset calculation unit that calculates statistical values of the frequency offsets Δφₖ, Δφₖ₊₁, . . . , and Δφ_{k+L-1} calculated by each of the plurality of calculation units 155.

$$[ Math . 2 ]$$

$$\frac{1}{L} {\sum }_{i = k}^{L - 1} \sum Δ {ϕ}_{i} \qquad Formula ( 2 )$$

The addition unit 157 adds the statistical value of the frequency offset calculated by the calculation unit 156 and the frequency offset stored in the buffer 159. For example, in the example illustrated in FIG. 2, the addition unit 157 adds the statistical value Δφ of the frequency offset calculated by the calculation unit 156 and the value stored in the buffer 159. The value stored in the buffer 159 is a cumulative value φ(k−1) of the frequency offset amount up to the signal of r(k). Therefore, the addition unit 157 outputs the phase value of φ(k−1)+Δφ as an addition result.

The calculation unit 158 compensates for the frequency offset occurring in the signal of each symbol by rotating the phase of the received signal using the addition result by the addition unit 157. Specifically, the calculation unit 158 rotates the phase of the signal r(k+n−1) by φ(k−1)+nΔφₖ. For example, the calculation unit 158 rotates the phase of the signal r(k) by the phase value φ(k−1)+Δφ output from the addition unit 157. For example, the calculation unit 158 rotates the phase of the signal r(k+1) by the phase value φ(k−1)+2Δφ. For example, the calculation unit 158 rotates the phase of the signal r(k+N−1) by the phase value φ(k−1)+NΔφ.

A cumulative value of the frequency offset amount up to the signal of r(k) is stored in the buffer 159.

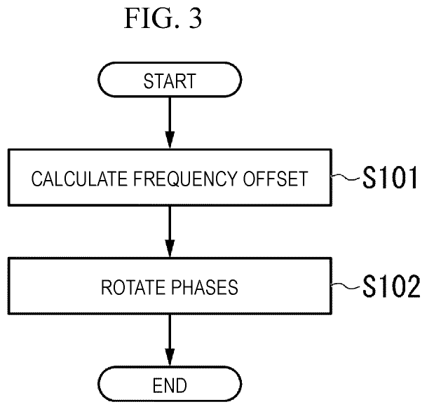

FIG. 3 is a flowchart illustrating a flow of processing of the reception device 1 according to the embodiment. Here, the processing of the frequency offset compensation unit 15 will be specifically described. The frequency offset compensation unit 15 calculates a frequency offset using the digital signal that has been subjected to the adaptive equalization processing by the adaptive equalization unit 14 (step S101). The specific processing will be described below.

The frequency offset compensation unit 15 calculates the complex conjugate of the signal r(k−1) of the (k−1)-th symbol, which is a symbol immediately before the signal r(k) of the k-th symbol, in the calculation unit 151. Next, the frequency offset compensation unit 15 multiplies the signal r(k) of the k-th symbol by the complex conjugate of the signal r(k−1) of the (k−1)-th symbol, which is a symbol immediately before the signal r(k) of the k-th symbol, in the multiplication unit 152. Next, the frequency offset compensation unit 15 calculates the m-th power of the multiplication result in the calculation unit 153.

Next, the frequency offset compensation unit 15 adds a plurality of symbols in the calculation unit 154. Next, the frequency offset compensation unit 15 performs angle calculation on the addition result of the plurality of symbols in the calculation unit 155, and divides the value after the angle calculation by m. Accordingly, the frequency offset compensation unit 15 calculates the frequency offset Δφₖ for the signal r(k) of the k-th symbol.

Similarly, the frequency offset compensation unit 15 calculates the complex conjugate of the signal r(k) of the k-th symbol, which is a symbol immediately before the signal r(k+1) of the (k+1)-th symbol, in the calculation unit 151. Next, the frequency offset compensation unit 15 multiplies the signal r(k+1) of the (k+1)-th symbol by the complex conjugate of the signal r(k) of the k-th symbol, which is a symbol immediately before the signal r(k+1) of the (k+1)-th symbol, in the multiplication unit 152. Next, the frequency offset compensation unit 15 calculates the m-th power of the multiplication result in the calculation unit 153.

Next, the frequency offset compensation unit 15 adds a plurality of symbols in the calculation unit 154. Next, the frequency offset compensation unit 15 performs angle calculation on the addition result of the plurality of symbols in the calculation unit 155, and divides the value after the angle calculation by m. Accordingly, the frequency offset compensation unit 15 calculates the frequency offset Δφₖ₊₁ for the signal r(k+1) of the (k+1)-th symbol.

The frequency offset calculation unit of the frequency offset compensation unit 15 performs the above-described processing on the signals r(k), r(k+1), . . . , r(k+L−1) of each symbol of the received signal to calculate the frequency offsets Δφₖ, Δφₖ₊₁, . . . , Δφ_{k+L-1} of the signals r(k), r(k+1), . . . , r(k+L−1) of each symbol. Each calculation unit 155 outputs the calculated frequency offsets Δφₖ, Δφₖ₊₁, . . . , Δ_{φk+L-1} to the calculation unit 156. The calculation unit 156 calculates a statistical value Δφ of the frequency offsets Δφₖ, Δφₖ₊₁, . . . , Δφ_{k+L-1} calculated by each calculation unit 155. The calculation unit 156 outputs the calculated statistical value Δφ to the addition unit 157.

The addition unit 157 adds the statistical value Δφ and the frequency offset stored in the buffer 159. The addition unit 157 outputs the addition result to each calculation unit 158. The frequency offset compensation unit 15 rotates the phases of the signals r(k), r(k+1), . . . , r(k+L−1) of each symbol (step S102). Specifically, the first-stage calculation unit 158 multiplies the signal r(k) of the k-th symbol by exp[−j{φ(k−1)+Δφ}]. Accordingly, the first-stage calculation unit 158 rotates the phase of the signal r(k) of the k-th symbol by φ(k−1)+Δφ.

Similarly, the second-stage calculation unit 158 multiplies the signal r(k+1) of the (k+1)-th symbol by exp[−j{φ(k−1)+2Δφ}]. Accordingly, the second-stage calculation unit 158 rotates the phase of the signal r(k+1) of the (k+1)-th symbol by (k−1)+2Δφ. The third-stage calculation unit 158 multiplies the signal r(k+2) of the (k+2)-th symbol by exp[−j{φ(k−1)+3Δφ}]. Accordingly, the third-stage calculation unit 158 rotates the phase of the signal r(k+2) of the (k+2)-th symbol by φ(k−1)+3Δφ.

According to the reception device 1 configured as described above, it is possible to reduce the number of sequential processing operations for frequency offset compensation and implement parallel processing. Specifically, the reception device 1 calculates the frequency offset Δφₖ on the basis of the signal r(k), and rotates the phase of the signal r(k+n−1) by φ(k−1)+nΔφₖ. The process of rotating the phase of the received signal as illustrated in the above Formula (1) can be expressed by a matrix. Therefore, as in the related art, it is possible to reduce the number of sequential processing operations for frequency offset compensation and implement parallel processing. As a result, low resource implementation in hardware is enabled.

### Modification Example 1

In a case where the reception device 1 according to the above-described embodiment is applied to an optical line terminal (OLT) in a passive optical network (PON), a burst signal is transmitted from an optical network unit (ONU). Therefore, in order to correspond to a burst signal, the reception device 1 may be configured to store the frequency offset Δφ of each optical network unit (ONU) in the buffer 159 and utilize the frequency offset Δφ at the time of next burst signal reception.

### Modification Example 2

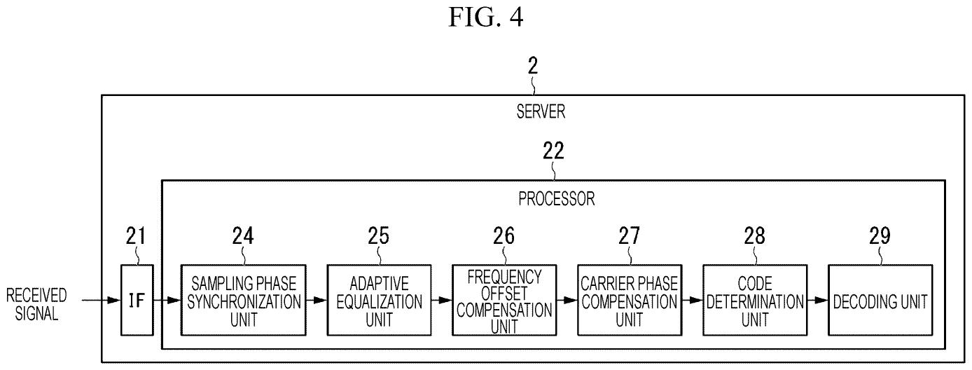

The above-described functions of the digital signal processor 11 and the decoding unit 12 may be configured to be implemented by a processor such as a central processing unit (CPU) or a graphics processing unit (GPU) provided in a general-purpose server. FIG. 4 is a diagram illustrating an example of a configuration of a server 2 in a second modification example. The server 2 is configured using a general-purpose information processing device. The server 2 is one aspect of a communication device.

The server 2 includes an IF 21 and a processor 22. The IF 21 is a data transfer board (for example, a network interface card (NIC)), converts a received signal into an electrical signal, and outputs the electrical signal to the processor 22. The processor 22 executes the program to implement the functions of the sampling phase synchronization unit 24, the adaptive equalization unit 25, the frequency offset compensation unit 26, the carrier phase compensation unit 27, the code determination unit 28, and the decoding unit 29. All or some of functions of the processor 22 may be implemented using hardware such as an application specific integrated circuit (ASIC), a programmable logic device (PLD), or a field programmable gate array (FPGA). The above program may be recorded in a computer-readable recording medium. The computer-readable recording medium is, for example, a portable medium such as a flexible disk, a magneto-optical disk, a read only memory (ROM), a compact disc read only memory (CD-ROM), or a semiconductor storage device (for example, a solid state drive (SSD)), or a storage device such as a hard disk or a semiconductor storage device built in a computer system. The above program may be transmitted via a telecommunication line.

The processing performed by the sampling phase synchronization unit 24, the adaptive equalization unit 25, the frequency offset compensation unit 26, the carrier phase compensation unit 27, the code determination unit 28, and the decoding unit 29 is the same as the processing performed by the sampling phase synchronization unit 13, the adaptive equalization unit 14, the frequency offset compensation unit 15, the carrier phase compensation unit 16, the code determination unit 17, and the decoding unit 12 illustrated in FIG. 1, and thus, a detailed description of the processing of each function will be omitted.

As described above, even a general-purpose server can easily implement the function of frequency offset compensation by converting the function of frequency offset compensation into software to form a program to be executed on the server 2. As a result, high-speed processing by software becomes possible.

Some functions of the reception device 1 in the above-described embodiments may be implemented by a computer. In such a case, a program for implementing the functions may be recorded in a computer-readable recording medium, and the functions may be implemented by loading the program recorded on this recording medium to a computer system, and executing the program. Note that the “computer system” mentioned herein includes an operating system (OS) and hardware such as peripheral devices.

Also, the “computer-readable recording medium” is a portable medium such as a flexible disk, a magneto-optical disk, a ROM, or a CD-ROM, or a storage device such as a hard disk embedded in the computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. Also, the foregoing program may be for implementing some of the functions described above, may be implemented in a combination of the functions described above and a program already recorded in a computer system, or may be implemented with a programmable logic device such as an FPGA.

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention can be applied to a communication device that performs frequency offset compensation.

### REFERENCE SIGNS LIST

1 Reception device
2 Server
11 Digital signal processor
12, 29 Decoding unit
13, 24 Sampling phase synchronization unit
14, 25 Adaptive equalization unit
15, 26 Frequency offset compensation unit
16, 27 Carrier phase compensation unit
17, 28 Code determination unit
21 IF
22 Processor
151, 153, 154, 155, 156, 158 Calculation unit
152 Multiplication unit
157 Addition unit
159 Buffer

1. A communication device comprising:
a receiver configured to receive a modulated signal including signals of a plurality of symbols; and
a frequency offset compensator configured to calculate a frequency offset of each signal of each symbol included in the modulated signal received by the receiver, calculate a statistical value of a calculated frequency offset of each signal of each symbol, and compensate for the frequency offset by rotating a phase of a signal of each symbol on the basis of a calculated statistical value of the frequency offset and a value of the frequency offset corresponding to the signal of each symbol.

2. The communication device according to claim 1, wherein,
in a case where the signal of each symbol is represented by r(k+n) (k is an integer equal to or greater than 1, and n is an integer equal to or greater than 0), the frequency offset compensator rotates the phase of the signal r(k+n−1) of each symbol by φ(k−1)+nφk.

3. A frequency offset compensation method comprising:
receiving a modulated signal including signals of a plurality of symbols; and
calculating a frequency offset of each signal of each symbol included in a received modulated signal, calculating a statistical value of a calculated frequency offset of each signal of each symbol, and compensating for the frequency offset by rotating a phase of a signal of each symbol on the basis of a calculated statistical value of the frequency offset and a value of the frequency offset corresponding to the signal of each symbol.

4. A non-transitory storage medium that stores a program for making a computer perform processes, the processes comprising:
receiving a modulated signal including signals of a plurality of symbols; and
calculating a frequency offset of each signal of each symbol included in a modulated signal received, calculating a statistical value of a calculated frequency offset of each signal of each symbol, and compensating for the frequency offset by rotating a phase of a signal of each symbol on the basis of a calculated statistical value of the frequency offset and a value of the frequency offset corresponding to the signal of each symbol.
